(19) United States
(12) Patent Application Publication
(10) Pub. No.: US 2012/0300487 A1
(43) Pub. Date: Nov. 29, 2012

(54) Mobile Lighting Apparatus

(76) Inventor: John Jonker, Ironbark (AU)

(21) Appl. No.: 13/357,998

(22) Filed: Jan. 25, 2012

(30) Foreign Application Priority Data
May 24, 2011 (AU) 2011202403

(51) Int. Cl. B60Q 1/076; B23P 17/04

(52) U.S. Cl. 362/526; 29/401.1

(57) ABSTRACT

Mobile lighting apparatus includes a base, traction means adapted to engage the ground, traction drive means connected to said traction means and including a hydraulic pump driven by a first internal combustion engine, a turret mounted on said base for pivoting or rotating movement about a substantially vertical axis, turret drive means for driving said turret about said vertical axis, electricity generation means mounted to said turret for pivoting or rotating movement therewith and including an alternator or generator driven by a second internal combustion engine, an extendable boom pivotally mounted to said turret, lighting means connected to said boom at or adjacent its distal end; and electricity communication means connecting said lighting means to said electricity generation means, wherein said traction drive means is mounted on one side of said boom and said electricity generation means is mounted on the other side of said boom.

### FIELD OF THE INVENTION

This invention relates to mobile lighting apparatus.

The invention has particular application to mobile lighting apparatus of the type in which an array of lights is mounted to a boom which can be raised when in a desired location or on a desired site, for directing light onto a selected area and lowered for transport to another desired location or site.

### BACKGROUND OF THE INVENTION

One known mobile lighting apparatus includes a trailer with a boom and an array of lights mounted thereon which can be raised from a lowered position in which the boom is horizontal and can be secured in that position to a raised position in which the boom is vertical and can be secured in the vertical position. Such apparatus provides for operation of the lights only when the boom is in the vertical position and only provides for securement of the boom in either the horizontal or vertical positions.

Another known apparatus invented by the present applicant has a travelling base with a pivoting turret thereon and a boom mounted to the turret with an array of lights at its distal end and having an engine driven generator unit also mounted to the turret in a predetermined position so as to act as a counterweight to the boom and the lighting array.

The present invention is aimed at providing mobile lighting apparatus which does not need the engine driven generator unit to be positioned behind the boom as a counterweight in that position and which is still relatively stable.

### SUMMARY OF THE INVENTION

With the foregoing in view, the present invention resides broadly in mobile lighting apparatus, including:
a base;
traction means operatively connected to said base and adapted to engage the ground for moving said base relative thereto;
traction drive means operatively connected to said traction means for driving said traction means along the ground, said traction drive means including a hydraulic pump driven by a first internal combustion engine;
a turret mounted on said base for pivoting or rotating movement relative thereto about a substantially vertical axis;
turret drive means for driving said turret about said substantially vertical axis;
electricity generation means mounted to said turret for pivoting or rotating movement therewith, said electricity generation means including an alternator or generator driven by a second internal combustion engine;
an extendable boom pivotally mounted at or adjacent its proximal end to said turret for movement relative thereto between a lowered position and a raised position;
lighting means operatively connected to said boom at or adjacent its distal end; and
electricity communication means connecting said lighting means to said electricity generation means; and
wherein said traction drive means is mounted on one side of said boom and said electricity generation means is mounted on the other side of said boom.

Preferably, said electricity communication means includes a power cable arranged to fold and unfold on a tray or rack mounted to said boom as said boom retracts and extends.

In another aspect, the invention resides broadly in a method of converting lifting apparatus to lighting apparatus as previously described, the lifting apparatus having a base, traction means operatively connected to the base and adapted to engage the ground for moving the base relative thereto, and traction drive means operatively connected to the traction means for driving the traction means along the ground, a turret mounted on the base for pivoting or rotating movement relative thereto about a substantially vertical axis and turret drive means for driving the turret about the substantially vertical axis, an extendable boom pivotally mounted at or adjacent its proximal end to the turret for movement relative thereto between a lowered position and a raised position, and a counterweight mounted to said turret to counter the weight of the boom, said traction drive means including a first internal combustion engine and a hydraulic pump mounted on said turret, the method including:

removing said first traction drive means and remounting it on said turret in a first predetermined position on one side of said boom;

mounting electricity generation means to said turret in a second predetermined position on the other side of said boom, said electricity generation means including an alternator or generator driven by a second internal combustion engine;

connecting lighting means to said boom at or adjacent its distal end; and

electrically connecting said electricity generation means to said lighting means for supplying power thereto.

Preferably, said first and second predetermined positions are selected such that said traction drive means and said electricity generation means substantially balance each other on opposite sides of said boom. Suitably, balancing the traction drive means and the electricity generation means improves the stability of the apparatus.

The terms “horizontal” and ‘vertical” are intended to describe the orientation of the particular axis or component being referred to when the apparatus is at rest on a level horizontal surface even though the axis or component may not be geometrically exactly vertical or horizontal. Further, such terms are not intended to limit the apparatus to use in any particular orientation.

BRIEF DESCRIPTION OF THE INVENTION

In order that the invention may be more easily understood and put into practical effect, reference will now be made to the accompanying drawings wherein:

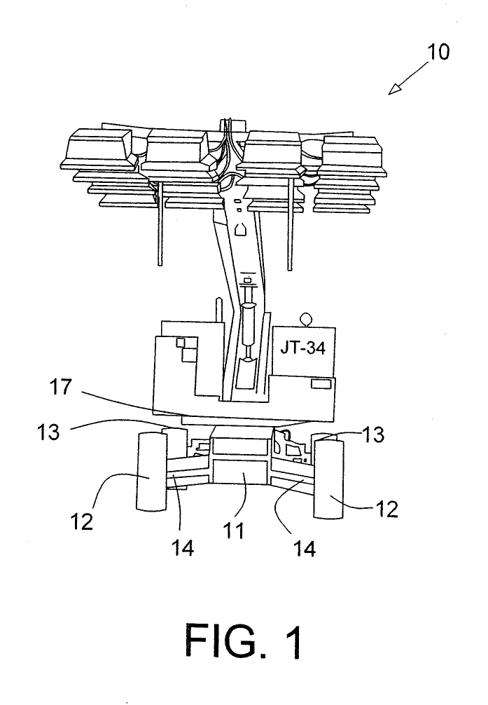

FIG. 1 is a perspective view of lighting apparatus according to the invention from the front with the turret in the travelling position and the boom in the fully lowered position and fully retracted;

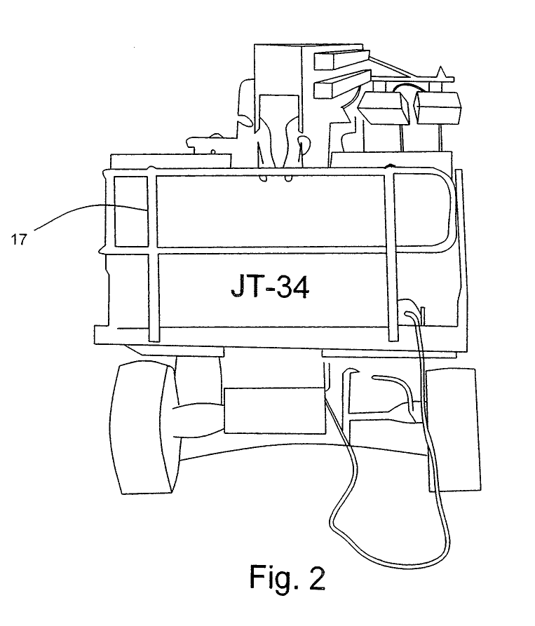

FIG. 2 is a perspective view of the apparatus of FIG. 1 from the rear with the turret in the travelling position and the boom fully lowered and fully retracted;

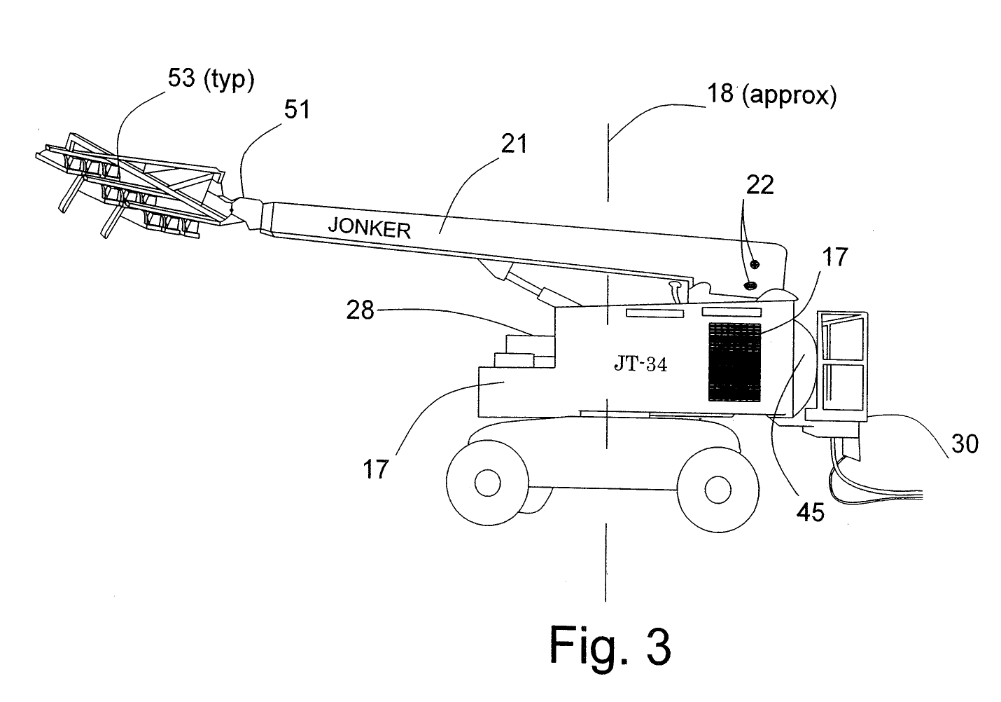

FIG. 3 is a perspective view of the apparatus of FIG. 1 from the near side with the turret in the travelling position and the boom in a slightly raised position and fully retracted;

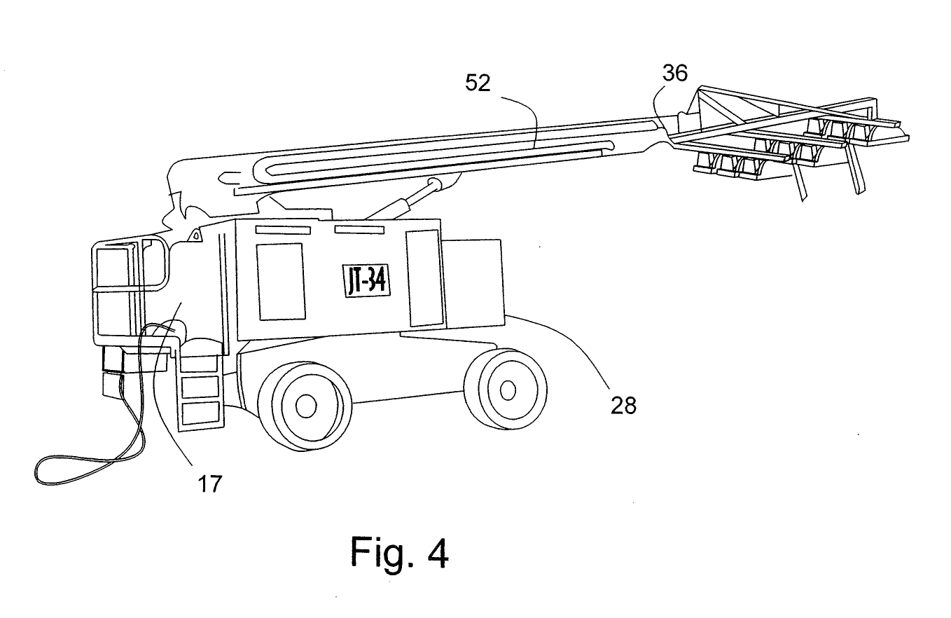

FIG. 4 is a perspective view of the apparatus of FIG. 1 from the off side with the turret in the travelling position and the boom in the almost fully lowered position and fully retracted;

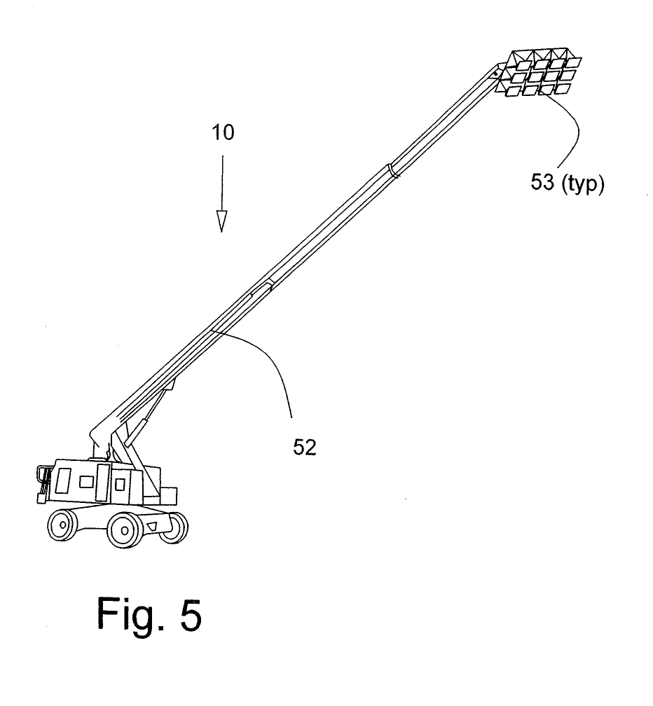

FIG. 5 is a perspective view of the apparatus of FIG. 1 from the off side with the turret in the travelling position and the boom in the almost fully raised position and fully extended;

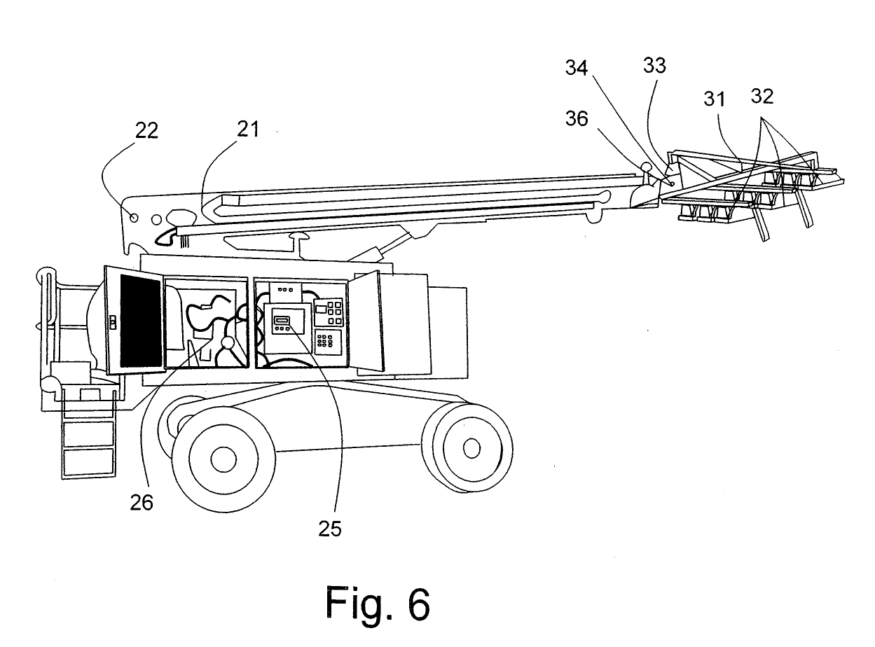

FIG. 6 is a perspective view of the apparatus of FIG. 1 from the off side with the turret in the travelling position and the boom in the almost fully lowered position and fully retracted with the generator access doors open; and

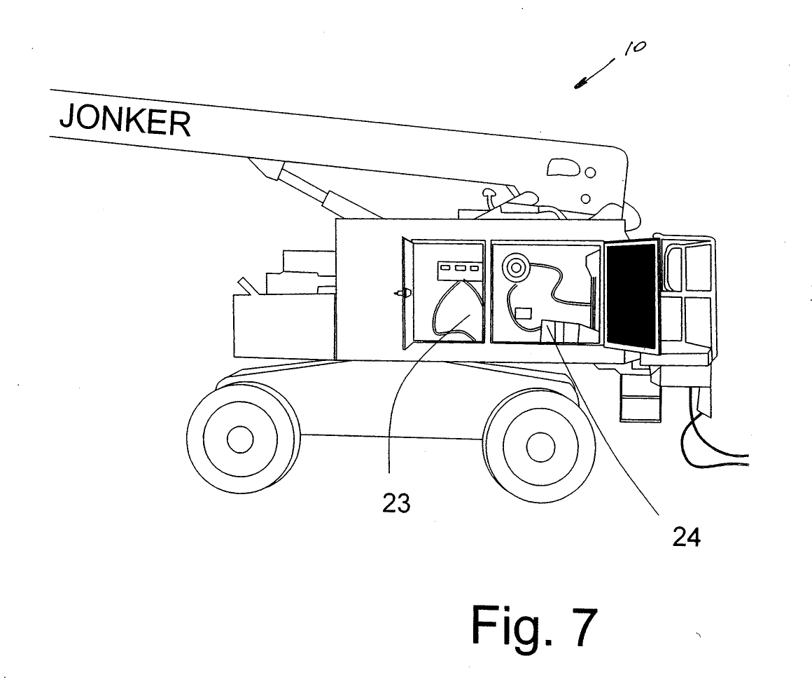

FIG. 7 is a perspective view of the apparatus of FIG. 1 from the near side with the turret in the travelling position and the boom in the almost fully lowered position and fully retracted with the traction drive access doors open.

### DETAILED DESCRIPTION OF THE INVENTION

The lighting apparatus 10 illustrated in FIG. 1 has been converted from lifting apparatus according to the method previously described. Apparatus 10 includes a base (or chassis) 11 which is supported on two spaced apart front wheels 12 and two spaced apart rear wheels 13 which are drivingly connected to respective hydraulic traction motors 14 in known manner for providing motive power to the wheels. The front wheels are arranged to pivot about respective vertical or inclined axes for steering the apparatus in the usual manner of four wheeled vehicles of this type.

A turret 17 is mounted on the base 11 for pivoting (or rotating) movement about a vertical axis 18 also in known manner for apparatus of this type and driven by a hydraulic motor (not visible in the drawings). An extendable boom 21 is mounted to the turret for up and down movement about a horizontal pivot pin 22 also in known manner for apparatus of this type.

A hydraulic pump 23 driven by diesel engine 24 is mounted in the turret on the near side of the boom for supplying hydraulic fluid to drive the hydraulic traction motors and the hydraulic motor for pivoting the turret, as well as hydraulic rams for raising, lowering and extending and retracting the boom 21 in known manner while a generator 25 driven by a diesel engine 26 is mounted in the turret on the off side of the boom to more or less balance the turret. Advantageously, the diesel engine driven generator unit and the diesel engine driven hydraulic pump are mounted in a predetermined position to give additional counter weight for the boom beyond the standard counterweight 27 which is retained in its original position. Suitably, both diesel engines draw fuel from the one tank 28 which is mounted on the turret in front of the generator unit while a hydraulic oil storage tank 29 is mounted on the turret in front of the hydraulic pump. It will be appreciated that the turret has been extended forward in order to accommodate the two tanks. Advantageously, a work or maintenance platform 30 with safety rails 30a has been fitted to the rear end of the turret. Suitably, the work platform provides support for the turret if the rear wheels 13 sink into the ground thereby maintaining stability.

A lighting frame 31 having an array of lights 32 mounted thereon is connected to the outer end 33 of the boom by a pivot pin 34 for up and down movement relative to the boom with a hydraulic ram 36 arranged to selectively raise and lower the frame.

A power cable 51 extends from the generator unit 25 on a “cat rack” type tray 52 mounted on the side of boom 21 (although in some embodiments it passes through the boom) and is connected at one end to a distribution box 52 mounted on the lighting frame 32, the cable being hidden in the drawings by the tray 52. Additional smaller cables distribute power from the distribution box to individual lights 53 mounted on the frame.

In use, when temporary lighting is required at a site, for example an excavation site, machinery breakdown repairs, road works, sporting events and the like, the lighting apparatus is transported to the site by truck where it is unloaded via ramps in known manner. The apparatus can then be driven to the desired position under its own motive power by operation of a controller on the turret or by a remote controller connected to the turret by a cable or wireless controller for controlling the engine driven hydraulic pump. When the apparatus is in the desired location, the boom can be raised and extended to a desired elevated position by actuating the relevant control valves and then the generator can be started to supply power to the lights.

In the apparatus illustrated in FIG. 1 the generator unit has a 50 KVA generator and the array of lights require 24 KW so it will be appreciated that the generator has sufficient capacity to provide for a more powerful array of lights if desired. The boom of the apparatus illustrated is selected to be able to hold the array of lights at a height of approximately 20 metres above the ground or in a generally horizontal position over an excavation face. However, apparatus of greater or lesser lighting power and greater or lesser boom length could be constructed if desired.

The foregoing description has been given by way of illustrative example of the invention and many modifications and variations which will be apparent to persons skilled in the art may be made without departing from the spirit and scope of the invention as defined by the appended claims.

1. Mobile lighting apparatus, including:
a base;
traction means operatively connected to said base and adapted to engage the ground for moving said base relative thereto;
traction drive means operatively connected to said traction means for driving said traction means along the ground, said traction drive means including a hydraulic pump driven by a first internal combustion engine;
a turret mounted on said base for pivoting or rotating movement relative thereto about a substantially vertical axis;
turret drive means for driving said turret about said substantially vertical axis;
electricity generation means mounted to said turret for pivoting or rotating movement therewith, said electricity generation means including an alternator or generator driven by a second internal combustion engine;
an extendable boom pivotally mounted at or adjacent its proximal end to said turret for movement relative thereto between a lowered position and a raised position;
lighting means operatively connected to said boom at or adjacent its distal end; and
electricity communication means connecting said lighting means to said electricity generation means; and
wherein said traction drive means is mounted on one side of said boom and said electricity generation means is mounted on the other side of said boom.

2. Mobile lighting apparatus according to claim 1 wherein said traction means includes a pair of spaced apart front wheels and a pair of spaced apart rear wheels and said traction means is drivingly connected to one of said pair of wheels.

3. Mobile lighting apparatus according to claim 2, wherein at least one of said pair of wheels is steerable.

4. Mobile lighting apparatus according to claim 1 wherein said traction drive means includes an engine and gearbox or one or more hydraulic motors drivingly connected to said traction means independently of said electricity generation means.

5. Mobile lighting apparatus according to claim 1 wherein said lighting means includes a frame having an array of lights mounted thereon.

6. Mobile lighting apparatus according to claim 5 wherein said frame is operatively connected to said boom for up and down movement relative thereto.

7. Mobile lighting apparatus according to claim 6 including one or more hydraulic rams for causing up and down movement of said frame relative to said boom.

8. Mobile lighting apparatus according to claim 1 wherein said electricity communication means includes a cable extending along the side of the boom and connected to a distribution box mounted on the lighting frame.

9. A method of converting lifting apparatus to lighting apparatus, the lifting apparatus having a base, traction means operatively connected to the base and adapted to engage the ground for moving the base relative thereto, and traction drive means operatively connected to the traction means for driving the traction means along the ground, a turret mounted on the base for pivoting or rotating movement relative thereto about a substantially vertical axis and turret drive means for driving the turret about the substantially vertical axis, an extendable boom pivotally mounted at or adjacent its proximal end to the turret for movement relative thereto between a lowered position and a raised position, and a counterweight mounted to said turret to counter the weight of the boom, said traction drive means including a first internal combustion engine and a hydraulic pump mounted on said turret, the method including:
removing said first traction drive means and remounting it on said turret in a first predetermined position on one side of said boom;
mounting electricity generation means to said turret in a second predetermined position on the other side of said boom, said electricity generation means including an alternator or generator driven by a second internal combustion engine;
connecting lighting means to said boom at or adjacent its distal end; and
electrically connecting said electricity generation means to said lighting means for supplying power thereto.
